(19) United States
(12) Patent Application Publication
(10) Pub. No.: US 2008/0237433 A1
(43) Pub. Date: Oct. 2, 2008

(54) Picture perfect corners

(76) Inventor: Russell Alan Hardin, Westport, CT (US)

Correspondence Address: Russell A. Hardin, 58 North Avenue, Westport, CT, 06880, US

(21) Appl. No.: 12/074,688

(22) Filed: Mar. 6, 2008

Related U.S. Application Data
(60) Provisional application No. 60/921,095, filed on Mar. 31, 2007.

(51) Int. Cl. B44C 5/02

(52) U.S. Cl. 248/467

(57) ABSTRACT

Utilizing my invention enables one to hang a frame or mirror in a level position and for it to remain level. The rubber male and female square component corners, with adhesive backs, keep frames from shifting by holding them in place when a set of each (male and female) are affixed to the bottom back corners of a frame. Each of the components have an adhesive back. The female component (FIG. 2) adheres to the frame and the male component (FIG. 1) adheres to the wall. The male and female components can easily be separated if necessary, to facilitate cleaning or repair. Frames can be re-hung at the same level position by re-joining the applied female components on the frame to the applied male components on wall (Drawings 1+2 A, 1+2 B and 1+2 C.)

### CROSS-REFERENCE TO RELATED APPLICATIONS

Not applicable

### STATEMENT REGARDING FEDERALLY SPONSORED RESEARCH OR DEVELOPMENT

Not applicable

### REFERENCE TO SEQUENCE LISTING, A TABLE OR A COMPUTER PROGRAM LISTING COMPACT DISC APPENDIX

Not applicable

### BACKGROUND OF INVENTION

This invention will maintain a frame hanging in a level position once it is hung on a wall. It is to be used in the field of residential and office decor and design. A provisional patent for this invention was filed on Mar. 31, 2007: application No. 60/921,095; confirmation number 7604.

### BRIEF SUMMARY OF THE INVENTION

This invention provides a solution to the problem of crooked picture frames. When applied this invention holds a frame in a fixed, level position once hung on a wall. The design also allows for said frames to be taken down by disengaging the joined male and female rubber pads, affixed to their back lower corners. The frame can be re-hung in the same level position by re-joining the female rubber pads affixed to the frame and the male rubber pads that remain affixed to the wall.

### BRIEF DESCRIPTION OF THE SEVERAL VIEWS OF THE DRAWING

FIG. 1 depicts the size and thickness of the male rubber pad and illustrates the size & depth of the circular flat protrusion at its center that will insert into the female rubber component's circular hole in its center.

FIG. 2 depicts the size and thickness of the female rubber pad and illustrates the size and depth of the circular hole in its center that receives the male circular protrusion. Drawings 1+2 A, 1+2 B and 1+2 C depict both male (FIG. 1) and female (FIG. 2) components in a sideways viewpoint illustrating the location of the adhesive back of each, detailed by the black and white, dashed vertical line. An enlarged view can be seen in

FIG. 3. Drawings 1+2 A, 1+2 B and 1+2 C illustrate how the male component (FIG. 1) is joined with the female component (FIG. 2).

### DETAILED DESCRIPTION OF THE INVENTION

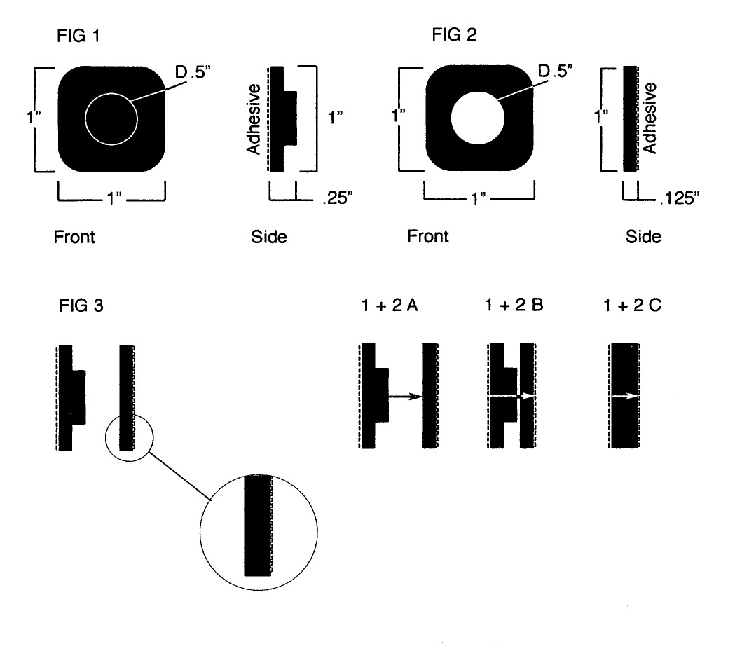

The interlocked male and female adhesive-backed square rubber pads are to be fabricated in a flexible rubber material. Each component is to be sized as illustrated in drawings FIG. 1 and FIG. 2 so as to join together and remain so, due to the male component being inserted snugly in to its female counterpart. The components are temporarily held together by the material resistance of the male rubber protrusion being inserted snuggly in to its female rubber counterpart. There is adequate resistance created to hold the components together provided by the flexible nature of the rubber material but not so as to make their separation difficult when necessary. The joining and application process is as follows: 1. The male and female rubber pads are joined by inserting the circular male protrusion (FIG. 1) in to its female round receptacle (FIG. 2). Two of these joined sets are required for each frame. 2. After both sets have been squarely joined together (Drawing 1+2 C) the protective paper backs are removed from the female components (FIG. 2) to reveal their adhesive outer surfaces (Drawing 1+2 A). 3. The adhesive female side of the joined set (Drawing 1+2 C) is squarely affixed to the lower back corner of the frame. The second prepared set is then attached in the same manner to the opposite bottom corner of the frame. 4. The backs of the male components are now exposed face up. Their protective papers are removed revealing their adhesive backs (Drawing 1+2 A). 5. A small level is taped to the top of the frame so that it is easily visible. 6. The frame is then re-hung on a nail or hook in the wall, with the bottom of the frame held away from the wall. 7. Once the picture is hanging and the level shows that it's straight, the lower two bottom corners (with the adhesive backs of the male components exposed) are pressed against the wall. 8. The frame is now held squarely level and in place. The frame can be removed by separating the male (FIG. 1) and female (FIG. 2) components. This leaves the female components (FIG. 2) attached to the frame and the male components (FIG. 1) affixed to the wall, as applied.

1. My invention, as described in this specification and illustrated in the identified drawing, is a unique solution to the home decor and design problem of frames not remaining in a level position once hung on a wall. The design and fabrication of the male and female interlocking rubber components with adhesive backs are my invention along with their specific application in home decor and design.
My invention as described in this specification and illustrated in the supplied drawing is not limited to, nor solely dependent upon, the natural flexible characteristics of rubber to keep the male and female components temporarily joined. Alternate fabrications of the same design concept, using interlocking magnets or magnetized surfaces in place of flexible rubber, could be effective.
As stated in the “Detailed Description Of The Invention” portion of this specification, my invention, the interlocking male (FIG. 1) and female (FIG. 2) rubber corners, can, in addition to their illustrated square format for which a patent is being sought through this application, be fabricated in an L-shaped, circular or rectangular shape. The specific design of these interlocking male (FIG. 1) and female (FIG. 2) square adhesive backed components, considering their possible alternative fabrication shapes, an adhesion system utilizing adhesive filament, an alternate temporary joining system using magnets or magnetized surfaces, the specific application of the above to maintain a level position for frames hung on walls, pertaining to residential or business, constitute the core of my patent claim application.
